(19) United States
(12) Patent Application Publication
(10) Pub. No.: US 2005/0077875 A1
(43) Pub. Date: Apr. 14, 2005

(54) Battery cell balancing circuit

(76) Inventor: Thomas K. Bohley, Colorado Springs, CO (US)

Correspondence Address: Richard A. Koske;Fluke Corporation, P.O. Box 9090, Everett, WA, 98206-9090, US

(21) Appl. No.: 10/686,292

(22) Filed: Oct. 14, 2003

(51) Int. Cl. H02J 7/00

(52) U.S. Cl. 320/119

(57) ABSTRACT

A simple, low-cost system for continuously balancing the voltage of serially-connected multiple cells of a battery. A voltage divider is connected across two adjacent cells to establish a reference voltage. A differential amplifier compares the reference voltage with the voltage at the junction of the two cells. If these voltages are equal, the cell voltages are balanced. If there is any significant deviation in these voltages, a current generator is turned on to slightly charge the cell with the lower voltage or discharge the cell with the higher voltage, depending on which cell has the higher voltage. Additional cells and balancing circuits may be added to provide the desired number of cells.

### BACKGROUND OF THE INVENTION

This invention relates generally to multiple-cell series-connected batteries, and in particular to a circuit for maintaining balance between cell voltages.

It is common to use rechargeable multiple-cell series-connected battery packs for a wide range of dc voltage power supply applications. It is commonly understood by those skilled in the art that charging and discharging the battery packs through normal operation over time results in cell-to-cell variations in battery voltage due to slight differences in physical characteristics of the cells, even if all the cells are nominally identical. Conventional charging circuits monitor individual cell voltage, and when any cell reaches its full-charge voltage, charging of the entire battery pack is terminated, even though other cells may not be fully charged. Similarly, on discharge, when any cell reaches the minimum allowable voltage, discharge is terminated. Thus, it can be discerned that that if the individual series-connected cells in a battery pack are unbalanced, that is, if such cells are not all charged to the same voltage, the available battery capacity is reduced. Moreover, batteries such as lithium-ion types should not be over-charged or over dis-charged because damage will result.

There are numerous methods for balancing or equalizing cell voltages of multiple-cell batteries, most of which involve detecting a cell that has a higher voltage than other cells in the battery, and then shunting charging current away from the detected cell, thereby limiting the charge voltage. This type of equalization system typically includes a controller or microprocessor that uses complicated algorithms to detect exceeded maximum voltage, to select cells, and to control charging and discharging processes.

An exemplary conventional method of balancing cells is disclosed in U.S. Pat. No. 6,285,161 to Popescu, wherein the voltage of each cell is compared with a threshold voltage. If the threshold voltage is exceeded for a given cell, a bleeder current is generated. The bleeder current may be subtracted from the charging current to that cell, or multiplied and subtracted from total charge current under computer control.

It would be desirable to provide a multiple-cell voltage balancing system that continuously balances the cell voltage without the need for expensive microcontrollers and complicated algorithms.

### SUMMARY OF THE INVENTION

In accordance with the present invention, a simple, low-cost system for continuously balancing the voltage of serially-connected multiple cells of a battery is provided. A voltage divider is connected across two adjacent cells to establish a reference voltage. A differential amplifier compares the reference voltage with the voltage at the junction of the two cells. If these voltages are equal, the cell voltages are balanced. If there is any significant deviation in these voltages, a current generator is turned on to slightly charge the cell with the lower voltage or discharge the cell with the higher voltage, depending on which cell has the higher voltage. Additional cells and balancing circuits may be added to provide the desired number of cells.

Other objects, features, and advantages of the present invention will become obvious to those having ordinary skill in the art upon a reading of the following description when taken in conjunction with the accompanying drawings.

### BRIEF DESCRIPTION OF THE DRAWINGS

FIG. 1 is a schematic diagram of a balancing circuit for a two-cell battery in accordance with the present invention; and

FIG. 2 is a schematic diagram of a balancing circuit for a three-cell battery in accordance with the present invention.

### DETAILED DESCRIPTION OF THE INVENTION

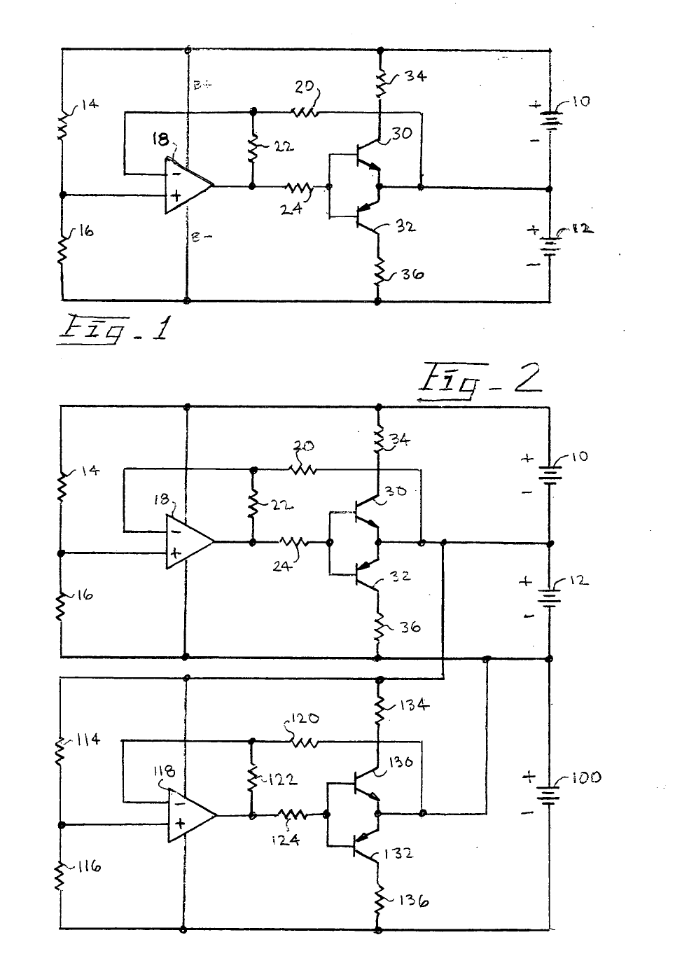

Referring to FIG. 1 of the drawings, there is shown a schematic diagram of a balancing circuit for a two-cell battery in accordance with the present invention. Two nominally equal cells 10 and 12 are connected in series. A voltage divider comprising equal-valued resistors 14 and 16 is connected in series across cells 10 and 12 to provide a reference voltage at the junction thereof. The non-inverting (+) input of an operational amplifier 18 is connected to the junction of resistors 14 and 16, while the inverting (−) input thereof is coupled through a resistor 20 to the junction of cells 10 and 12. A feedback resistor 22 is connected across the non-inverting input and output of operational amplifier 18. The output of operational amplifier 18 is coupled through a resistor 24 to the common bases of emitter-coupled current switch transistors 30 and 32, which together with collector resistors 34 and 36 form current generators which are connected across battery cells 10 and 12, respectively. Note that transistors 30 and 32 are opposite polarity, with transistor 30 being a pnp type and transistor 32 being an npn type. The common emitters of transistors 30 and 32 are connected to the junction of cells 10 and 12.

It can be discerned that operational amplifier 18 functions as a differential amplifier, comparing the reference voltage at the junction of resistors 14 and 16 with the voltage at the junction of cells 10 and 12 and generating a comparison signal in response to the difference in voltages. Ideally, these voltages should be equal, and, in fact, this is the balanced condition. In the balanced condition, transistors 30 and 32 are both biased off because their base and emitter voltages are the same. However, due to imbalances in the physical properties of cells 10 and 12, differences in voltage across the cells are inevitable. This particularly true as the cells are charged and discharged over time in normal usage.

To get a clear understanding of the balancing circuit operation, let us suppose that voltage provided by cell 10 becomes greater than the voltage provided by cell 12 due to the aforementioned differences in physical properties of the cells. Operational amplifier 18 continuously compares the reference voltage with the cell-junction voltage, and detects that the reference voltage provided by voltage divider 14-16 is higher (more positive) than the cell-junction voltage and generates a positive-going comparison signal. Through the action of operational amplifier 18, the base of transistor 30 is driven positive with respect to its emitter, turning transistor 30 on as it is biased into conduction. Transistor 32 remains turned off. Current provided by the current generator formed by resistor 43 and transistor 30 flows into cell 12, charging cell 12 at a faster rate than cell 10 (or allowing cell 10 to discharge slightly as current is shunted away from cell 10), until cells 10 and 12 each have the same voltage thereacross, which is the balanced condition. Transistor 30 will turn off as the cells become balanced.

Likewise, if voltage of cell 12 becomes greater than the voltage of cell 10, transistor 32 is turned on by the negative-going comparison signal from operational amplifier 18, driving the base of transistor 32 negative with respect to its emitter. The current generator formed by resistor 36 and transistor 32 shunts current away from cell 12, allowing cell 10 to charge at a faster rate (or cell 12 to discharge slightly) until the cells are once again balanced.

Amplifier gain is set by resistors 20 and 22 such that a voltage imbalance of approximately 10 millivolts will activate the balancing circuit. This small dead zone allows the cells to have small variations in voltage during charge and discharge. In normal operation, cells 10 and 12 will remain fairly well balanced and the balancing circuit will activate only briefly to insure that the cell balance does not deteriorate over time. It is apparent, then, that the balancing circuit may be activated whenever the cells are unbalanced, and it does not matter whether they are being charged or discharged. It happens automatically, and no microprocessors or complicated algorithms are required. As a practical matter, however, while the balancing can take place at any time, it will most likely occur during a battery charging cycle when the battery voltages reach levels sufficient to allow the balancing circuit to function properly. Of course, if it is desired to balance the cells only during battery charging in order to reduce current consumption, operational amplifier 18 may be enabled during the charge cycle and disabled at all other times. This may be easily implemented by placing switches in the B+ and B− power connections to operational amplifier 18, and connecting power to operational amplifier 18 only during the charge cycle. The balancing circuit conducts a small continuous current which does not significantly affect the life of the battery. The values of resistors 14 and 16 are chosen to minimize current drain. For example, assuming cells 10 and 12 are each 1.5 volts, and resistors 14 and 16 are each 50 kilohms, current through the divider resistors is 30 microamperes. The amount of current shunted by transistors 30 and 32 is set by the values of resistors 34 and 36.

For batteries having more than two cells, the balancing circuit is repeated for each additional cell. FIG. 2 shows a schematic diagram for an exemplary three-cell balancing circuit. In addition to the elements that have already been described in connection with FIG. 1, a new cell 100 has been added. That is, the three-cell circuit includes cells 10, 12, and 100. The balancing of cells 10 and 12 is as described in connection with FIG. 1, and like reference numerals apply to like circuit elements.

A voltage divider comprising equal-valued resistors 114 and 116 is connected in series across cells 12 and 100 to provide a reference voltage. The non-inverting (+) input of an operational amplifier 118 is connected to the junction of resistors 114 and 116, while the inverting (−) input thereof is coupled through a resistor 120 to the junction of cells 12 and 100. A feedback resistor 122 is connected across the non-inverting input and output of operational amplifier 118. The output of operational amplifier 118 is coupled through a resistor 124 to the common bases of emitter-coupled current switch transistors 130 and 132, which together with collector resistors 134 and 136 form current generators which are connected across battery cells 12 and 100, respectively. Again note that transistors 130 and 132 are opposite polarity, with transistor 130 being a pnp type and transistor 132 being an npn type. The common emitters of transistors 130 and 132 are connected to the junction of cells 12 and 100.

The circuit operation for balancing cells 12 and 100 is identical to that described above for balancing cells 10 and 12. The result of the circuit balancing operation is that all three cells 10, 12, and 100 will each have the same voltage thereacross.

It can be discerned by one having ordinary skill in the art that n additional cells may be added in series, with an attendant additional balancing circuit for each cell. For example, suppose we were to add a fourth cell in series with cells 10, 12, and 100. Another voltage divider, operational amplifier, and emitter-coupled current switches would be needed to balance the voltages of cell 100 and the new cell. The new balancing circuit would be connected as shown and described in connection with FIG. 1, where cells 10 and 12 would be replaced by cell 100 and the new cell. Additional cells and balancing circuits may be implemented in the same manner.

While I have shown and described the preferred embodiment of my invention, it will be apparent to those skilled in the art that many changes and modifications may be made without departing from my invention in its broader aspects. It is therefore contemplated that the appended claims will cover all such changes and modifications as fall within the true scope of the invention.

1. A circuit for balancing cell voltages in a multiple-cell battery, comprising:
means for comparing voltage at a junction of a first cell and a second cell with a reference voltage and generating a comparison signal in response to a difference between said junction voltage and said reference voltage; and
a first current generator connected across said first cell and a second current generator connected across said second cell, said current generators being normally in an off state, wherein only one of said first and second current generators is turned on at a time in response to said comparison signal.

2. A circuit in accordance with claim 1 wherein said reference voltage is provided by a voltage divider connected across said first and second cells.

3. A circuit in accordance with claim 1 wherein said comparison means comprises a differential amplifer.

4. A circuit in accordance with claim 1 wherein said first and second current generators each comprise a transistor and a resistor in series with a collector thereof, said transistor being responsive to said comparison signal applied to a base thereof to function as a switch.

5. A circuit in accordance with claim 4 wherein said transistors are opposite polarity so as to allow only one transistor to conduct, depending on the polarity of said comparison signal.

6. A circuit for balancing cell voltages in a multiple-cell battery, comprising:
a voltage divider coupled across a series-connection of a first cell and a second cell;
a differential amplifier having a first input coupled to a midpoint of said voltage divider, and a second input coupled to a junction of said first and second cells, said differential amplifier generating a comparison signal upon detection of an unbalanced condition of said first and second cells; and
first and second current generators coupled respectively across said first and second cells, said first and second current generators each having a control element coupled to the output of said differential amplifier,
wherein one of said first and second current generators is turned on responsive to said comparison signal.

7. A circuit in accordance with claim 6 wherein said first and second current generators include first and second transistors.

8. A circuit in accordance with claim 7 wherein said first and second transistors each have a base, a collector, and an emitter, wherein the bases of said first and second transistors are coupled together to an output of said differential amplifier, said collectors are connected to respective current-setting resistors, and said emitters of said first and second transistors are coupled together to said junction of said first and second cells.

9. A circuit in accordance with claim claim 7 wherein said first and second transistors are opposite polarity.

10. A circuit in accordance with claim 6 wherein said differential amplifier may be enabled only during a battery charge cycle.
